(19) United States
(12) Patent Application Publication
(10) Pub. No.: US 2015/0007589 A1
(43) Pub. Date: Jan. 8, 2015

(54) SECONDARY CELL MODULE USING DIRECT HYDROCOOLING AND COOLING METHOD THEREOF

(71) Applicant: HYUNDAI MOBIS CO., LTD., Seoul (KR)

(72) Inventors: Yong Ho Lim, Suwon-si (KR); Kee Yang Lee, Hwaseong-si (KR); Yong Chun, Yongin-si (KR)

(21) Appl. No.: 14/321,588

(22) Filed: Jul. 1, 2014

(30) Foreign Application Priority Data
Jul. 5, 2013 (KR) 10-2013-0079249

(51) Int. Cl. H01M 10/613; H01M 10/653; H01M 10/625

(52) U.S. Cl. CPC H01M 10/5004; H01M 10/5016; H01M 10/504
USPC 62/62; 429/120

(57) ABSTRACT

A secondary cell module using direct hydrocooling may include: a secondary cell; and a housing containing the secondary cell and filled with a refrigerant. The secondary cell may be directly contacted with the refrigerant.

### CROSS-REFERENCES TO RELATED APPLICATIONS

The present application claims priority to Korean application number 10-2013-0079249, filed on Jul. 5, 2013, which is incorporated by reference in its entirety.

### BACKGROUND OF THE INVENTION

The present invention relates to a secondary cell module using direct hydrocooling and a cooling method thereof, and more particularly, to a secondary cell module using direct hydrocooling, in which a secondary cell is dipped into a refrigerant and cooled down while directly contacted with the refrigerant, and a cooling method thereof.

Cells may be classified into a primary cell and a secondary cell. The primary cell refers to a cell which cannot be reused after used one time, because the primary cell produces electricity using an irreversible reaction. The primary cell may include a battery, a mercury cell, a voltaic cell and the like, which are generally used. On the other hand, the secondary cell refers to a cell which can be reused after use, because the secondary cell is recharged through a reversible reaction. The secondary cell may include a lead storage battery, a lithium ion cell, a Ni—Cd cell and the like.

Recently, rechargeable secondary cells have been widely used as energy sources of wireless mobile devices. Furthermore, secondary cells have received public attention as energy sources of electric vehicles and hybrid electric vehicles, which are considered as an alternative for reducing air pollution caused by existing gasoline vehicles and diesel vehicles which use fossil fuel. Thus, the types of applications using a secondary cell have been diversified due to the advantages of the secondary cell. In the future, the secondary cells are expected to be used in more various fields and products than now.

In general, a unit secondary cell includes an anode, a cathode, an electrolyte, and a wire, and an electric vehicle requiring high power and large capacity uses a secondary cell pack having a plurality of secondary cells coupled to each other. That is, the secondary cell pack includes a plurality of unit secondary cells (unit cells) which are electrically coupled to each other as described above. Furthermore, the secondary cell pack including a plurality of unit cells may be housed in a case. In this case, the secondary cell pack may be protected from an external impact, and easily assembled into another component.

The secondary cell generates a large amount of gas and heat during a charge/discharge process. At this time, the generated gas expands the volume of the secondary cell and thus expands the case. Furthermore, since the generated heat deteriorates the secondary cell and thus reduces the electrochemical performance of the secondary cell, the heated secondary cell must be rapidly cooled down.

A cooling method for such a secondary cell may be roughly classified into a hydrocooling method and an air-cooling method. The hydrocooling method is to cool down the secondary cell using a heat exchange medium (refrigerant) such as cooling water. According to the hydrocooling method, a refrigerant pipe having a shape similar to a coil of an electric pad is mounted to transfer heat to the outside of the secondary cell, and a refrigerant is introduced into the refrigerant pipe so as to indirectly cool down the secondary cell through the heat transfer. For example, Korean Patent No. 1112442 discloses a battery module assembly which includes a plurality of battery modules and a plurality of cooling members. The plurality of battery modules are arranged adjacent to each other in a side-to-side direction in a state where the battery modules are electrically coupled to each other. Each of the battery modules includes a plurality of battery cells or unit modules coupled in series and embedded in a module case. The cooling members each including a refrigerant pipe for passing a liquid refrigerant are mounted on the outer surfaces of the respective battery modules.

The air-cooling method is to cool down a secondary cell using the external air. According to the air-cooling method, a cooling fan contacted with the secondary cell is used to send air, in order to indirectly reduce heat generated from the secondary cell through forced convection.

The hydrocooling method has excellent cooling efficiency. However, since the hydrocooling method has complex design and requires a chiller, a heater/cooler, and a cooling flow plate, the entire size of the battery module may be excessively increased. The air-cooling method has a simpler structure than the hydrocooling method, but has low cooling efficiency. Furthermore, when the amount of heat increases with the increase in number of charge and discharge operations for the secondary cell, cooling may be insufficiently performed. Furthermore, when an external short-circuit occurs, the secondary cell may ignite. However, since the air-cooling method does not have a fire control function for preventing an explosion caused by the ignition, the safety of the air-cooling method inevitably decreases. Furthermore, the air-cooling method has a limit in degree of freedom for design, because surrounding products such as a blower and a duct are required.

Therefore, there is a demand for the development of a cooling method capable of compensating for the disadvantages of the hydrocooling method and the air-cooling method.

Thus, the present inventor has developed a cooling method in which a secondary cell is dipped into a refrigerant and cooled down while directly contacted with the refrigerant, in order to improve cooling efficiency, the degree of freedom for design, and structural efficiency.

### SUMMARY OF THE INVENTION

Embodiments of the present invention are directed to a secondary cell module using direct hydrocooling.

In one embodiment, a secondary cell module using direct hydrocooling may include: a secondary cell; and a housing containing the secondary cell and filled with a refrigerant. The secondary cell may be directly contacted with the refrigerant.

The secondary cell module may include two or more secondary cells.

The secondary cells may be separated at a predetermined distance from each other.

The housing may include a conductive tap which is electrically coupled to an electrode terminal of the secondary cell.

The refrigerant may have a dielectric constant of about 0.5 to about 2 at 1 kHz.

The refrigerant may have a dielectric breakdown voltage of about 40 kV to about 70 kV.

The secondary cell may be housed in a case, and the case housed in the housing may be contacted with the refrigerant.

In another embodiment, a cooling method of a secondary cell module using direct hydrocooling may include: putting a secondary cell into a housing; and filing the housing with a refrigerant. The secondary cell may be directly contacted with the refrigerant.

The secondary cell module may include two or more secondary cells.

The secondary cells may be separated at a predetermined distance from each other.

The housing may include a conductive tap which is electrically coupled to an electrode terminal of the secondary cell.

The refrigerant may have a dielectric constant of about 0.5 to about 2 at 1 kHz.

The refrigerant may have a dielectric breakdown voltage of about 40 kV to about 70 kV.

In another embodiment, a cooling method of a secondary cell module using direct hydrocooling may include: putting a secondary cell housed in a case into a housing; and filling the case with a refrigerant. The refrigerant may be transferred through a flow path formed in the housing and contacted with the case.

### BRIEF DESCRIPTION OF THE DRAWINGS

FIG. 1 illustrates a secondary cell module in accordance with an embodiment of the present invention.

FIGS. 2A and 2B illustrate a secondary cell module in accordance with another embodiment of the present invention.

FIGS. 3A and 3B illustrate a secondary cell module in accordance with a further embodiment of the present invention.

FIG. 4 is a graph illustrating test results for capacity maintenance rates of Example 1 and Comparative Example 1.

FIG. 5A is a graph illustrating an output characteristic of Example 1.

FIG. 5B is a graph illustrating an output characteristic of Comparative Example 1.

### DESCRIPTION OF SPECIFIC EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

An aspect of the present invention relates to a secondary cell module using direct hydrocooling.

A secondary cell used in the present invention may include any secondary cells, as long as the secondary cells can be charged and discharged. For example, the secondary cell may include a lithium secondary cell, a nickel-hydrogen (Ni-MH) secondary cell, a nickel-cadmium (Ni—Cd) secondary cell and the like. Among the secondary cells, the lithium secondary cell may be used because the lithium secondary cell provides high power in comparison to the weight thereof.

Furthermore, the secondary cell may have a rectangular shape, a cylindrical shape, or a pouch shape. Desirably, a pouch-shaped secondary cell may be used. When the pouch-shaped secondary cell is used, the manufacturing cost may be reduced, energy density may be increased, and a large-capacity cell pack may be implemented through serial or parallel coupling.

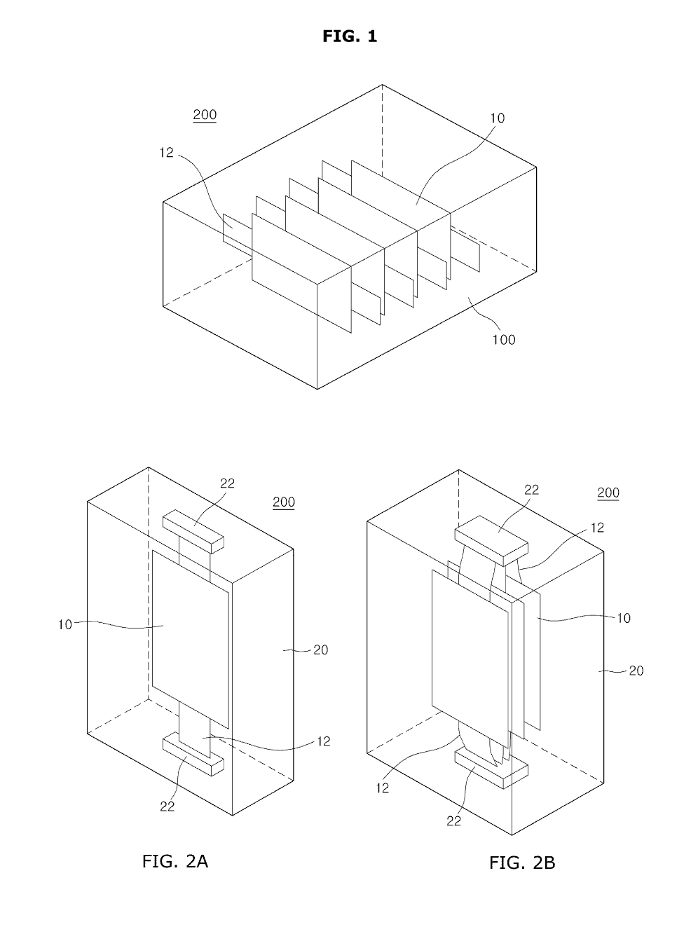

FIG. 1 illustrates a secondary cell module 200 in accordance with an embodiment of the present invention. Referring to FIG. 1, the secondary cell module 200 may include a secondary cell 10 and a housing 100 filled with a refrigerant and housing the secondary cell 10.

As illustrated in FIG. 1, the secondary cell 10 may include an electrode terminal 12, and the electrode terminal 12 of the secondary cell 10 may be electrically coupled to the housing 100.

In one embodiment, the secondary cell module 200 may include one or more secondary cells 10, in order to provide a high power and large capacity. For example, two or more secondary cells 10 may be included in the secondary cell module 200. As illustrated in FIG. 1, the secondary cells 10 may be separated at a predetermined distance from each other. When the predetermined distance is provided, the secondary cells 10 and the refrigerant may be easily contacted with each other, thereby improving a cooling effect.

In one embodiment, the housing 100 may include a conductive tap (not illustrated) to electrically couple the secondary cell 10 and the electrode terminal 12.

In one embodiment, the secondary cells 10 included in the housing 100 may be dipped into the refrigerant stored in the housing 100 and directly contacted with the refrigerant. When the secondary cell 10 is dipped into the refrigerant and contacted with the refrigerant, cooling may be performed while a capacity loss of the secondary cell 10 or performance degradation caused by a short circuit does not occur even in a wide external temperature range of about −50° C. to about 128° C. Furthermore, since the secondary cell 10 is dipped into the refrigerant and directly contacted with the refrigerant unlike the existing hydrocooling and air-cooling methods, the secondary cell module 200 has a fire control function for ignition of the secondary cell 10 caused by an external short circuit. Thus, since the safety of the secondary cell module 200 is improved, the secondary cell module 200 may provide reliability under a vehicle operation condition (about −40° C. to about 125° C.).

The refrigerant used in the present invention may include typical refrigerants. For example, any refrigerants may be used as long as the refrigerants have a dielectric constant k of about 2 or less at 1 kHz and a dielectric breakdown voltage of about 40 kV or more. In one embodiment, the dielectric constant k may range from about 0.5 to about 2.0 at 1 kHz, and the dielectric breakdown voltage may range from about 40 kV to about 70 kV. When the refrigerant having the above-described conditions is applied to cool down the secondary cell 10, the secondary cell 10 may be stably cooled down while a capacity loss of the secondary cell 10 or electric short circuit does not occur even in the wide temperature range of about −50° C. to about 128° C.

In one embodiment, the refrigerant may include any one selected from perfluorocarbon (PFC), hydrofluorocarbon (HFC), and hydrochlorofluorocarbon (HCFC)-based compounds, but is not limited thereto. Desirably, a perfluorocarbon-based compound having a carbon number of 7 to 9 may be used. The above-described types of refrigerants may have a strongly electrical insulation property.

Examples of products used as the refrigerant may include FC-3283, FC-40, and FC-43 made by 3M, but are not limited thereto. When the above-described type of refrigerant is applied to cool down the secondary cell 10, the secondary cell 10 may be stably cooled down while a capacity loss of the secondary cell 10 or electric short circuit does not occur even in the wide temperature range of about −50° C. to about 128° C.

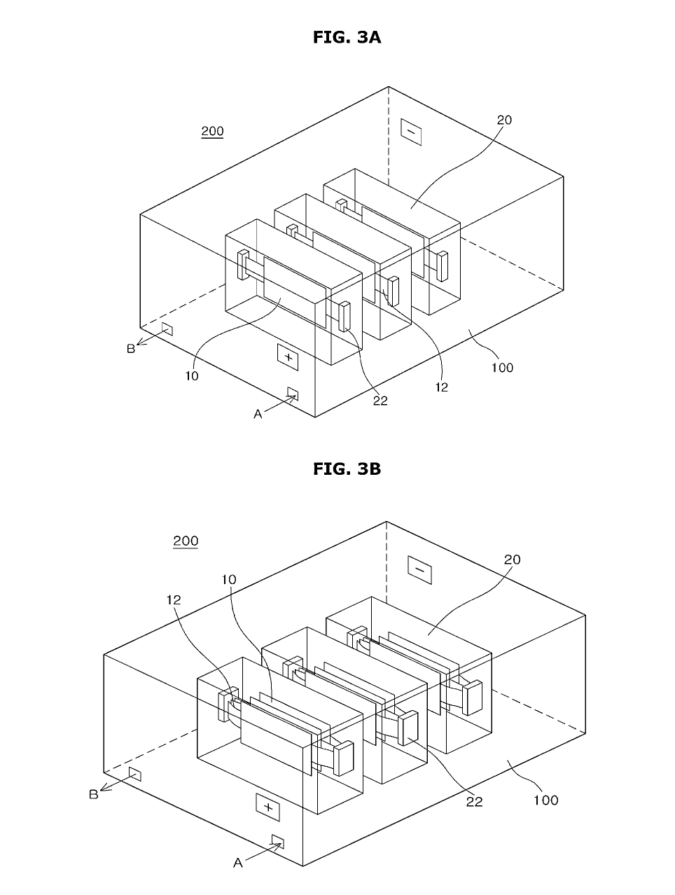

FIGS. 2A and 2B illustrate a secondary cell module 200 in accordance with another embodiment of the present invention.

Referring to FIG. 2A, the secondary cell module 200 in accordance with the embodiment of the present invention may include the secondary cell 10 and a case 20 housing the secondary cell 10 and filled with a refrigerant. In one embodiment, an electrode terminal 12 formed at the secondary cell 10 and a conductive tap 22 formed on the housing 20 may be electrically coupled and housed in the case 20 so as to form the secondary cell module 200.

Referring to FIG. 2B, one or more secondary cells 10 may be included in the case 20, in order to provide a high power and large capacity. In one embodiment, an electrode terminal 12 formed at each of the one or more secondary cells 10 and a conductive tap 22 formed on the case 20 may be electrically coupled to form the secondary cell module 200.

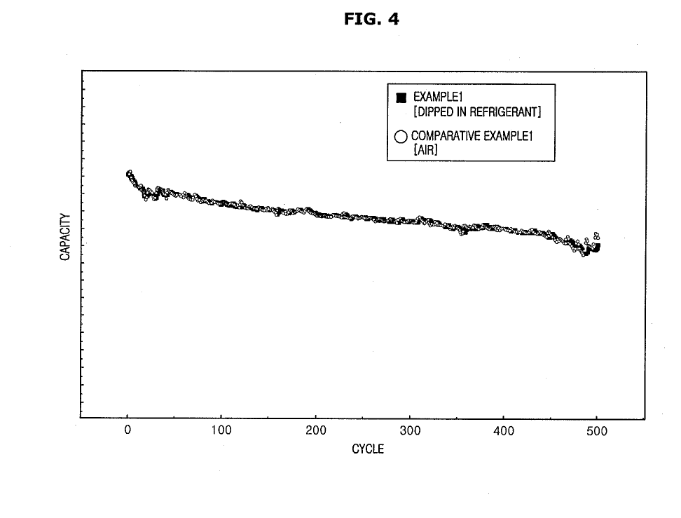

FIGS. 3A and 3B illustrate a secondary cell module 200 in accordance with a further embodiment of the present invention. Referring to FIG. 3A, the secondary cell 10 may be housed in the case 20, and the case 20 housed in the housing 100 may be contacted with a refrigerant.

In one embodiment, one or more cases 20 may be included in the housing 100.

Referring to FIG. 3B, an electrode terminal 12 formed at each of the one or more secondary cells 10 and a conductive tap 22 formed on the case 20 may be electrically coupled to form the secondary cell module 200.

Referring to FIGS. 3A and 3B, the housing 100 may include a refrigerant inlet A for introducing a refrigerant and a refrigerant outlet B for discharging the refrigerant. Furthermore, the refrigerant inlet A and the refrigerant outlet B may be formed on the same surface of the housing 100 or formed to face each other.

In one embodiment, the refrigerant may be introduced into the refrigerant inlet A and directly contacted with the secondary cell 10 inside the case 20. The refrigerant introduced into the housing 100 may be contacted with the case 20. The refrigerant introduced into the housing 100 may be transferred through a flow path (not illustrated) formed in the housing 100 and contacted with the case 20.

In the present embodiment, the housing 100 may be formed of metal or plastic. As the metal, nickel, titanium, aluminum, copper, steel, stainless steel, and an alloy thereof may be used independently or mixed and used.

The plastic may include any one selected from polyethylene (PE), polypropylene (PP), polyvinyl chloride (PVC), polyvinylidene chloride (PVDC), polyethylene terphthalate (PET), polycarbonate (PC) and nylon. When the above-described material is used, the housing 100 may not be damaged even though the above-described refrigerant is injected to perform cooling. Compared to existing housings formed of metal, the entire weight of the housing 100 may be reduced.

The case 20 in accordance with the embodiment of the present invention may be formed of metal or plastic. As the metal, nickel, titanium, aluminum, copper, steel, stainless steel, and an alloy thereof may be used independently or mixed and used.

The plastic may include any one selected from polyethylene (PE), polypropylene (PP), polyvinyl chloride (PVC), polyvinylidene chloride (PVDC), polyethylene terphthalate (PET), polycarbonate (PC) and nylon. When the above-described material is used, the case 20 may not be damaged even though the above-described refrigerant is injected to perform cooling. Compared to existing cases formed of metal, the entire weight of the case 20 may be reduced.

Another aspect of the present invention relates to a cooling method of the secondary cell module 200 using direct hydrocooling.

In one embodiment of the present invention, the cooling method may include putting a secondary cell 10 into a housing 100 and filling the housing 100 with a refrigerant. In one embodiment, one or more secondary cells 10 may be included in the housing 100, in order to provide a high power and large capacity, and directly contacted with the refrigerant stored in the housing 100.

The secondary cell 10 may include an electrode terminal 12 as illustrated in FIG. 1, and the electrode terminal 12 of the secondary cell 10 may be electrically coupled to the housing 100.

In one embodiment, the secondary cell module 200 may include one or more secondary cells 10, in order to provide a high power and large capacity. For example, two or more secondary cells 10 may be included. As illustrated in FIG. 1, the secondary cells 10 may be separated at a predetermined distance from each other. When the predetermined distance is provided, the secondary cells 10 and the refrigerant may be easily contacted with each other, thereby improving the cooling effect.

In one embodiment, the housing 100 may include a conductive tap (not illustrated) formed to be electrically coupled to the electrode terminal 12 of the secondary cell 10.

The refrigerant used in the present invention may include typical refrigerants. For example, any refrigerants may be used as long as the refrigerants have a dielectric constant k of about 2 or less at 1 kHz and a dielectric breakdown voltage of about 40 kV o more. In one embodiment, the dielectric constant k may range from about 0.5 to about 2.0 at 1 kHz, and the dielectric breakdown voltage may range from about 40 kV to about 70 kV. When the refrigerant having the above-described conditions is applied to cool down the secondary cell 10, the secondary cell 10 may be stably cooled down while a capacity loss of the secondary cell 10 or electric short circuit does not occur even in a wide temperature range of about −50° C. to about 128° C.

In one embodiment, the refrigerant may include any one selected from perfluorocarbon (PFC), hydrofluorocarbon (HFC), and hydrochlorofluorocarbon (HCFC)-based compounds, but is not limited thereto. Desirably, a perfluorocarbon-based compound having a carbon number of 7 to 9 may be used. The above-described types of refrigerants may have a strongly electrical insulation property.

Examples of products used as the refrigerant may include FC-3283, FC-40, and FC-43 made by 3M, but are not limited thereto. When the above-described type of refrigerant is applied to cool down the secondary cell 10, the secondary cell 10 may be stably cooled down while a capacity loss of the secondary cell 10 or electric short circuit does not occur even in the wide temperature range of about −50° C. to about 128° C.

In another embodiment of the present invention, the cooling method may include putting a secondary cell 10 into a case 20 and filling the case 20 with a refrigerant. In one embodiment, one or more secondary cells 10 may be housed in the case 20, in order to provide a high power and large capacity, and the case 20 may be filled with a refrigerant.

In a further embodiment, the cooling method may include putting the secondary cell 10 housed in the case into a housing 20, and filling the housing 100 with a refrigerant.

In one embodiment, one or more secondary cells 10 may be housed in the case 20, in order to provide a high power and large capacity.

In one embodiment, one or more cases 20 may be included in the housing 100.

Referring to FIGS. 3A and 3B, the housing 100 may include a refrigerant inlet A for introducing the refrigerant and a refrigerant outlet B for discharging the refrigerant. Furthermore, the refrigerant inlet A and the refrigerant outlet B may be formed on the same surface of the housing 100 or formed to face each other.

In one embodiment, the refrigerant may be introduced into the housing 100 through the refrigerant inlet A. The refrigerant introduced into the housing 100 may be transferred through a flow path (not illustrated) formed in the housing and contacted with the case 20.

Hereafter, the configuration and operation of the present invention will be described in more detail with reference to preferred embodiments of the present invention. However, the preferred embodiments are only examples, and cannot limit the scope of the present invention.

The contents which are not described herein can be sufficiently inferred by those skilled in the art. Thus, the detailed descriptions thereof are omitted herein.

### Example 1

A case 20 formed of PET was filled with FC-3283 which is a refrigerant having a dielectric constant k of 1.9 at 1 kHz and made by 3M, a Li—Mn secondary cell having a pouch shape was dipped into the housing 100, an electrode 12 of the lithium secondary cell was electrically coupled to a conductive tap 22 formed on the case 20, and the lithium secondary cell and the refrigerant were directly contacted to form the secondary cell module 200 as illustrated in FIG. 2A.

### Example 2

In a housing 100, 72 cases 20 were housed, each containing a Li—Mn secondary cell having a pouch shape and formed of PET. An electrode 12 of the lithium secondary cell was electrically coupled to a conductive tap 22 formed on the case 20, the housing 100 was filled with FC-3283 made by 3M as a refrigerant, and the lithium secondary cell and the refrigerant were contacted to form the secondary cell module 200 as illustrated in FIG. 3A.

### Comparative Example 1

Except that no refrigerant is used, the same secondary cell module 200 as Example 1 was manufactured.

### Comparative Example 2

Except that no refrigerant is used and a blower and a duct are included for air-cooling, the same secondary cell module 200 as Example 2 was manufactured.

### Experimental Example

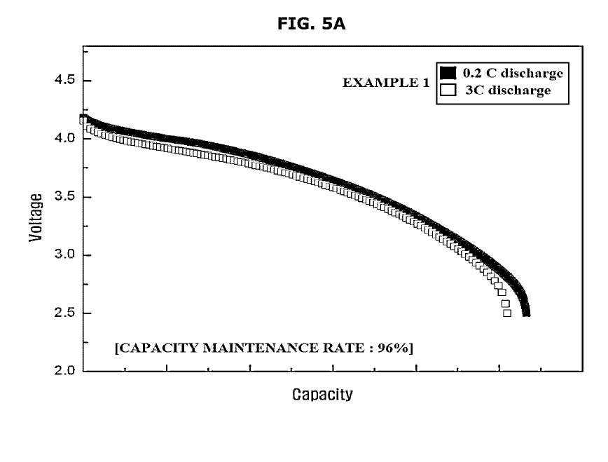

(1) Capacity maintenance rate test: 500 cycles of lifetime tests were performed to evaluate a capacity maintenance rate, while the secondary cell module 200 dipped in the refrigerant of Example 1 is repetitively charged and discharged with 1 C. Furthermore, the same Li—Mn secondary cell (Comparative Example 1) as Example 1 was tested in the air under the same condition. FIG. 4 shows the test results.

According to the test results, both of Example 1 and Comparative Example 1 show a capacity maintenance rate of 95% or more, and a capacity loss or short circuit does occur, which indicates that although the secondary cell module 200 is dipped into the refrigerant and cooled down through direct hydrocooling, the cooling method has no influence on the performance of the secondary cell 10.

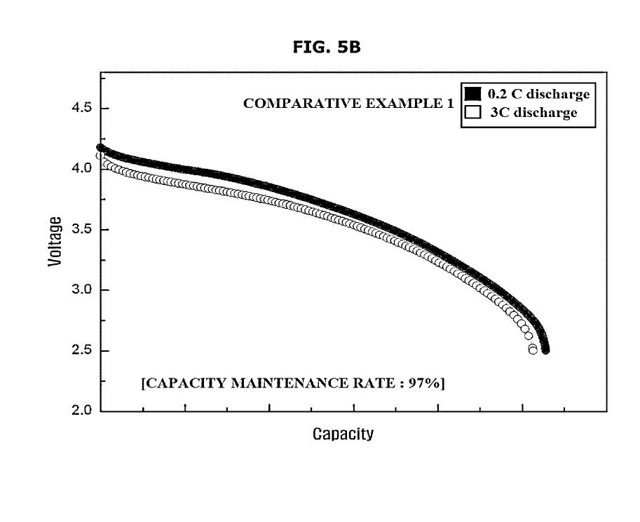

(2) Output characteristic test: the discharge capacity of the lithium secondary cell in the secondary cell module 200 manufactured in Example 1 was measured at 0.2 C and 3 C so as to evaluate an output characteristic. FIG. 5A shows the result. Furthermore, the same Li—Mn secondary cell (Comparative Example 1) as Example 1 was tested in the air under the same condition. FIG. 5B shows the result.

(3) Secondary cell saturation temperature: the secondary cell modules of Example 2 and Comparative Example 2 were cooled down through the air-cooling method (Comparative Example 2) and the hydrocooling method (Example 2) under the condition in which the external temperature is 35° C., and the saturation temperatures of the secondary cell modules of Example 2 and Comparative Example 2 were measured. Table 1 shows the measurement results.

TABLE 1

| | | | | Module saturation | | |
|---|---|---|---|---|---|---|
| | | | | temperature (° C.) | | |
| | Cooling | Cooling | External | Maximum | Minimum | Temperature |
| | method | fluid | temperature | temperature | temperature | difference |
| Comparative | Air cooling | Air | 35.0° C. | 41.3° C. | 40.7° C. | 1.3° C. |
| Example 2 | | | | | | |
| Example 2 | Direct | Refrigerant | 35.0° C. | 35.6° C. | 35.4° C. | 0.2° C. |
| | hydrocooling | | | | | |

Referring to FIGS. 4 and 5, both of Example 1 and Comparative Example 1 show an excellent output characteristic, which indicates that although the secondary cell module 200 is dipped into the refrigerant and cooled down through direct hydrocooling, the cooling method has no influence on the performance of the secondary cell 10.′

Furthermore, the results of Table 1 show that when the secondary cell module is cooled down through the direct hydrocooling method of Example 2, the saturation temperature of the module is reduced by 5° C. or more, compared to Comparative Example 2 in which the secondary cell module is cooled down through the air-cooling method.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A secondary cell module using direct hydrocooling, comprising:
a secondary cell; and
a housing containing the secondary cell and filled with a refrigerant,
wherein the secondary cell is directly contacted with the refrigerant.

2. The secondary cell module of claim 1, wherein the secondary cell module comprises two or more secondary cells.

3. The secondary cell module of claim 2, wherein the secondary cells are separated at a predetermined distance from each other.

4. The secondary cell module of claim 1, wherein the housing comprises a conductive tap which is electrically coupled to an electrode terminal of the secondary cell.

5. The secondary cell module of claim 1, wherein the refrigerant has a dielectric constant of about 0.5 to about 2 at 1 kHz.

6. The secondary cell module of claim 1, wherein the refrigerant has a dielectric breakdown voltage of about 40 kV to about 70 kV.

7. The secondary cell module of claim 1, wherein the secondary cell is housed in a case, and the case housed in the housing is contacted with the refrigerant.

8. A cooling method of a secondary cell module using direct hydrocooling, comprising:
putting a secondary cell into a housing; and
filing the housing with a refrigerant,
wherein the secondary cell is directly contacted with the refrigerant.

9. The cooling method of claim 8, wherein the secondary cell module comprises two or more secondary cells.

10. The cooling method of claim 9, wherein the secondary cells are separated at a predetermined distance from each other.

11. The cooling method of claim 8, wherein the housing comprises a conductive tap which is electrically coupled to an electrode terminal of the secondary cell.

12. The cooling method of claim 8, wherein the refrigerant has a dielectric constant of about 0.5 to about 2 at 1 kHz.

13. The cooling method of claim 8, wherein the refrigerant has a dielectric breakdown voltage of about 40 kV to about 70 kV.

14. A cooling method of a secondary cell module using direct hydrocooling, comprising:
putting a secondary cell housed in a case into a housing; and
filling the case with a refrigerant,
wherein the refrigerant is transferred through a flow path formed in the housing and contacted with the case.
